(19) United States
(12) Patent Application Publication
(10) Pub. No.: US 2013/0238891 A1
(43) Pub. Date: Sep. 12, 2013

(54) Method and System for Encrypting Short Message

(71) Applicants: Junsheng Sun, Shenzhen (CN); Pengbo Zhang, Shenzhen (CN); Yaobin Cao, Shenzhen (CN); Fangmin Deng, Shenzhen (CN); Tao Xue, Shenzhen (CN); Song Yu, Shenzhen (CN); Yulin Yang, Shenzhen (CN)

(72) Inventors: Junsheng Sun, Shenzhen (CN); Pengbo Zhang, Shenzhen (CN); Yaobin Cao, Shenzhen (CN); Fangmin Deng, Shenzhen (CN); Tao Xue, Shenzhen (CN); Song Yu, Shenzhen (CN); Yulin Yang, Shenzhen (CN)

(73) Assignee: ZTE CORPORATION, Shenzhen City, Guangdong Province (CN)

(21) Appl. No.: 13/641,517

(22) PCT Filed: Apr. 22, 2011
(86) PCT No.: PCT/CN2011/073192

§ 371 Date: Oct. 16, 2012

(30) Foreign Application Priority Data
Dec. 1, 2010 (CN) 201010568985.X

(51) Int. Cl. H04L 29/06

(52) U.S. Cl. CPC H04L 63/0471
USPC 713/153

(57) ABSTRACT

The present invention discloses a method and system for implementing short message encryption. Both the Mobile Station (MS) and the Mobile Switching Center (MSC) are configured with encryption-decryption modules (1), which can encrypt and decrypt the short message by using the Cipher Key (CK) as the encryption-decryption factor. The CK is variable with the Random value (RAND). The CK is not shared between the receiving end and the sending end in the whole process, so that the encrypted short message has a high confidentiality. In addition, the security of the whole transmission environment can be realized by the selectable configuration.

### TECHNICAL FIELD

The present invention relates to the mobile communication field, and in particular, to a method and system for implementing short message encryption.

### BACKGROUND ART

With the increasing popularization of mobile phone terminals, and SMS (short message services) has played a more and more significant role in people's daily life and has become an important communication way for people. Just because of the popularization of SMS, the security problem of SMS become more and more important. Because in many cases the short message will transmit important information, and once the information is intercepted, huge loss will be brought to the person. Due to the current fixed mechanism of SMS, the content of the message is stored in the PDU (Protocol Data Unit) structure with plaintext. How to ensure secure transmission of short messages becomes an important problem.

The existing short message encryption protection modes mainly include the following types:
(1) the short message that has been transmitted and received is protected from illegal access by adding access permission to the short message module of the mobile phone;
(2) the legal access of the short message is protected by performing special permission configuration for a single short message;
(3) the short message is protected by encrypting the content of the short message and by a key or password access;
(4) the secure transmission of a short message is achieved in the ciphertext manner by adding a security field and security content through an extended short message PDU, and the receiving party analyzes the security field to decrypt the final short message;
(5) the encryption information is firstly determined through the negotiation manner, and then the short message is transmitted.

Wherein, (1), (2) and (3) are all protection methods based on mobile phone side, and (4) and (5) are protection methods based on the wireless side and network side.

Generally speaking, the protection methods based on the wireless side and network side are more important than the protection methods based on mobile phone side since the mobile phone is commonly in our hands, so we pay more attention on the security of SMS in the wireless transmission and network transmission.

The existing protection methods of the wireless side and network side generally require an extension or modification of the short message PDU format, and in addition, the negotiation of encryption algorithm and transmission of the key should also be implemented. Wherein, the transmission of key and encryption algorithm is per se not secure.

### SUMMARY OF THE INVENTION

The technical problem to be solved in the present invention is to provide a method and system for implementing short message encryption so as to ensure secure transmission of the short message services (SMS).

In order to solve the above problem, the present invention provides a method for implementing short message encryption, comprising the following steps of:
a mobile station (MS) of a transmitting party encrypting a short message to be transmitted using a cipher key (CK) of the transmitting party as an encryption factor and then sending the short message out;
a mobile switching center (MSC) to which the MS of the transmitting party belongs decrypting the short message using the CK of the transmitting party as a decryption factor after receiving the short message, and then sending the short message to a short message service center (SC) through an interworking message service center (IWMSC);
after receiving the short message transmitted by the SC through a gateway mobile switching center (GMSC), an MSC to which an MS of a receiving party belongs encrypting the short message using a CK of the receiving party as an encryption factor, and then sending the short message to the MS of the receiving party;
after receiving the short message, the MS of the receiving party decrypting the short message using the CK of the receiving party as a decryption factor, thereby restoring a content of the short message.

Preferably, the above method further has the following feature:
the step of the MS of the transmitting party encrypting a short message to be transmitted using the CK of the transmitting party as an encryption factor and then sending the short message out comprises: the MS of the transmitting party encrypting user data (UD) of a protocol data unit (PDU) of the short message to be transmitted using the CK of the transmitting party as the encryption factor through an encryption-decryption module of itself, setting an encryption identifier in the PDU of the short message to be transmitted, and then sending the short message out;
the step of the MSC to which the MS of the transmitting party belongs decrypting the short message using the CK of the transmitting party as a decryption factor after receiving the short message comprises: after receiving the short message, if judging according to the encryption identifier that the short message is an encrypted short message, the MSC to which the MS of the transmitting party belongs decrypting the UD of the PDU of the short message using the CK of the transmitting party as the decryption factor through an encryption-decryption module of itself;
the step of the MSC to which the MS of the receiving party belongs encrypting the short message using the CK of the receiving party as an encryption factor after receiving the short message comprises: after receiving the short message, if judging according to the encryption identifier therein that the short message needs to be encrypted, the MSC to which the MS of the receiving party belongs encrypting the UD of the PDU of the short message using the CK of the receiving party as the encryption factor through an encryption-decryption module of itself;
the step of the MS of the receiving party decrypting the short message using the CK of the receiving party as a decryption factor after receiving the short message comprises: after receiving the short message, if judging according to the encryption identifier therein that the short message is an encrypted short message, the MS of the receiving party decrypting the UD of the PDU of the short message using the CK of the receiving party as the decryption factor through an encryption-decryption module of itself.

Preferably, the above method further has the following feature:
after decrypting the UD of the PDU of the short message, the MSC to which the MS of the transmitting party belongs encrypts the UD of the PDU of the short message using a user identifier of the receiving party as the encryption factor through the encryption-decryption module of itself, and then transmits the short message to the SC through the IWMSC;
after receiving the short message transmitted by the SC through the GMSC, if it is judged according to the encryption identifier therein that the short message needs to be encrypted, the MSC to which the MS of the receiving party belongs firstly decrypts the UD of the PDU of the short message using the user identifier of the receiving party as the decryption factor through the encryption-decryption module of itself, and then encrypts the UD of the PDU of the short message using the CK of the receiving party as the encryption factor.

Preferably, the above method further has the following feature:
the CK is calculated with a particular algorithm from a random value (RAND) of generated in an authentication process of the MS and MSC of a party to which the CK belongs and a root key (Ki) of a user.

Preferably, the above method further has the following feature:
the user identifier of the receiving party is a mobile subscriber international ISDN number (MSISDN) or International Mobile Subscriber Identification Number (IMSI) of the receiving party.

Preferably, the above method further has the following feature:
before the MS of the transmitting party encrypts the short message to be transmitted, the MS provides an interface for the user of the transmitting party to select whether to encrypt the short message to be transmitted, and if the user of the transmitting party selects to encrypt, the MS of the transmitting party encrypts the short message to be transmitted.

In order to solve the above problem, the present invention provides a method for transmitting an encrypted short message, comprising the following steps of:
a mobile station (MS) of a transmitting party encrypting a short message to be transmitted using a cipher key (CK) of the transmitting party as an encryption factor and then sending the short message out;
a mobile switching center (MSC) to which the MS of the transmitting party belongs decrypting the short message using the CK of the transmitting party as a decryption factor after receiving the short message, and then sending the short message to a short message service center (SC) through an interworking message service center (IWMSC).

Preferably, the above method further has the following feature:
the step of the MS of the transmitting party encrypting a short message to be transmitted using the CK of the transmitting party as an encryption factor and then sending the short message out comprises: the MS of the transmitting party encrypting user data (UD) of a protocol data unit (PDU) of the short message to be transmitted using the CK of the transmitting party as the encryption factor through an encryption-decryption module of itself, setting an encryption identifier in the PDU of the short message to be transmitted, and then sending the short message out;
the step of the MSC to which the MS of the transmitting party belongs decrypting the short message using the CK of the transmitting party as a decryption factor after receiving the short message comprises: after receiving the short message, if judging according to the encryption identifier that the short message is an encrypted short message, the MSC to which the MS of the transmitting party belongs decrypting the UD of the PDU of the short message using the CK of the transmitting party as the decryption factor through an encryption-decryption module of itself;

Preferably, the above method further has the following feature:
after decrypting the UD of the PDU of the short message, the MSC to which the MS of the transmitting party belongs encrypts the UD of the PDU of the short message using a user identifier of the receiving party as the encryption factor through the encryption-decryption module of itself, and then transmits the short message to the SC through the IWMSC.

In order to solve the above problem, the present invention provides a method for receiving an encrypted short message, comprising the following steps of:
after receiving the short message transmitted by a short message service center (SC) through a gateway mobile switching center (GMSC), an mobile switching center (MSC) to which a mobile station (MS) of a receiving party belongs encrypting the short message using a cipher key (CK) of the receiving party as an encryption factor and then sending the short message to the MS of the receiving party;
after receiving the short message, the MS of the receiving party decrypting the short message using the CK of the receiving party as a decryption factor, thereby restoring a content of the short message.

Preferably, the above method further has the following feature:
the step of the MSC to which the MS of the receiving party belongs encrypting the short message using the CK of the receiving party as an encryption factor after receiving the short message comprises: after receiving the short message, if judging according to the encryption identifier therein that the short message needs to be encrypted, the MSC to which the MS of the receiving party belongs encrypting the UD of the PDU of the short message using the CK of the receiving party as the encryption factor through an encryption-decryption module of itself;
the step of the MS of the receiving party decrypting the short message using the CK of the receiving party as a decryption factor after receiving the short message comprises: after receiving the short message, if judging according to the encryption identifier therein that the short message is an encrypted short message, the MS of the receiving party decrypting the UD of the PDU of the short message using the CK of the receiving party as the decryption factor through an encryption-decryption module of itself.

Preferably, the above method further has the following feature:
after receiving the short message transmitted by the SC through the GMSC, if it is judged according to the encryption identifier therein that the short message needs to be encrypted, the MSC to which the MS of the receiving party belongs firstly decrypts the UD of the PDU of the short message using the user identifier of the receiving party as the decryption factor through the encryption-decryption module of itself, and then encrypts the UD of the PDU of the short message using the CK of the receiving party as the encryption factor.

In order to solve the above problem, the present invention provides a system for implementing short message encryption, comprising an MS of a transmitting party, an MSC to which the MS of the transmitting party belongs, an MSC to which an MS of a receiving party belongs, the MS of the receiving party, and the MS and MSC of the transmitting party and the MS and MSC of the receiving party are all configured with encryption-decryption modules,
the MS of the transmitting party is configured to encrypt a short message to be transmitted using a cipher key (CK) of the transmitting party as an encryption factor through the encryption-decryption module of itself and then send the short message out;
the MSC to which the MS of the transmitting party belongs is configured to decrypt the short message using the CK of the transmitting party as a decryption factor after receiving the short message, and then send the short message to a short message service center (SC) through an interworking message service center (IWMSC);
the MSC to which the MS of the receiving party belongs is configured to encrypt the short message using a CK of the receiving party as an encryption factor through the encryption-decryption module of itself after receiving the short message transmitted by the SC through the GMSC and then send the short message to the MS of the receiving party;
the MS of the receiving party is configured to decrypt the short message using the CK of the receiving party as a decryption factor through the encryption-decryption module of itself after receiving the short message, thereby restoring a content of the short message.

In order to solve the above problem, the present invention provides a mobile station (MS), comprising a transmitting module and a receiving module, as well as an encryption-decryption module, the encryption-decryption module comprises an encryption sub-module and a decryption sub-module, wherein,
the encryption sub-module is configured to encrypt a short message to be transmitted using a current CK as an encryption factor, and send the short message out through the transmitting module;
the decryption sub-module is configured to decrypt the short message received by the receiving module using the current CK as a decryption factor, thereby restoring a content of the short message.

Preferably, the above MS further has the following feature:
the MS further comprises an interface module,
the interface module is configured to provide an interface for a user to select whether to encrypt the short message to be transmitted, and if the user selects to encrypt, inform the encryption module so that the encryption module encrypts the short message to be transmitted.

In order to solve the above problem, the present invention provides a mobile switching center (MSC), comprising a transmitting module and a receiving module, as well as an encryption-decryption module, the encryption-decryption module comprises an encryption sub-module and a decryption sub-module, wherein,
the decryption sub-module is configured to decrypt the short message using the CK of the transmitting party as a decryption factor after the receiving module receives the short message from the MS of the transmitting party, and then send the short message to a short message service center (SC) through the transmitting module;
the encryption sub-module is configured to encrypt the short message using a CK of the receiving party as an encryption factor after the receiving module receives the short message from the SC and then send the short message to the MS of the receiving party.

Preferably, the above MSC further has the following feature:
the encryption sub-module is further configured to, after the decryption sub-module decrypts the short message using the CK of the transmitting party, encrypt the short message using a user identifier of the receiving party as the encryption factor, and then transmit the short message to the SC through the transmitting module;
the decryption sub-module is further configured to, after the receiving module receives the short message from the SC, firstly decrypt the short message using the user identifier of the receiving party as the decryption factor, and then encrypt the short message using the CK of the receiving party as the encryption factor through the encryption sub-module.

Compared with the prior art, in the present invention, by adding a corresponding encryption-decryption module into the MS (Mobile Station) and MSC (Mobile Switching Center), the short message is encrypted and decrypted using the CK (Cipher Key) which is variable with the RAND (random value) as the encryption-decryption factor, and the key is highly protected during the whole process and is not shared between the receiving and transmitting ends, so that the encrypted short message has a high confidentiality. Moreover, the encryption-decryption module may be provided by the third party and embedded into the terminal and network device, and is configured to change the algorithm as needed and be responsible for performing encryption-decryption operation for the content data of the short message. In this way, even the network, terminal device supplier and operator cannot steal the encrypted short message. In addition, in the scheme of the present invention, the encryption factor is different at each time, which increases the difficulty of cracking from the wireless transmission environment. Besides, the security of the whole transmission environment can be achieved through optional configurations.

### BRIEF DESCRIPTION OF DRAWINGS

FIG. 1 illustrates the structure of the system for encrypting a short message according to an example of the present invention;

FIG. 2 is a flowchart of the MS sending an encrypted short message according to the present invention;

FIG. 3 a flowchart of the MS receiving an encrypted short message according to the present invention;

FIG. 4 a flowchart of sending an encrypted short message to the short message service center (SC) according to the present invention;

FIG. 5 a flowchart of the SC sending an encrypted short message to the receiving party according to the present invention.

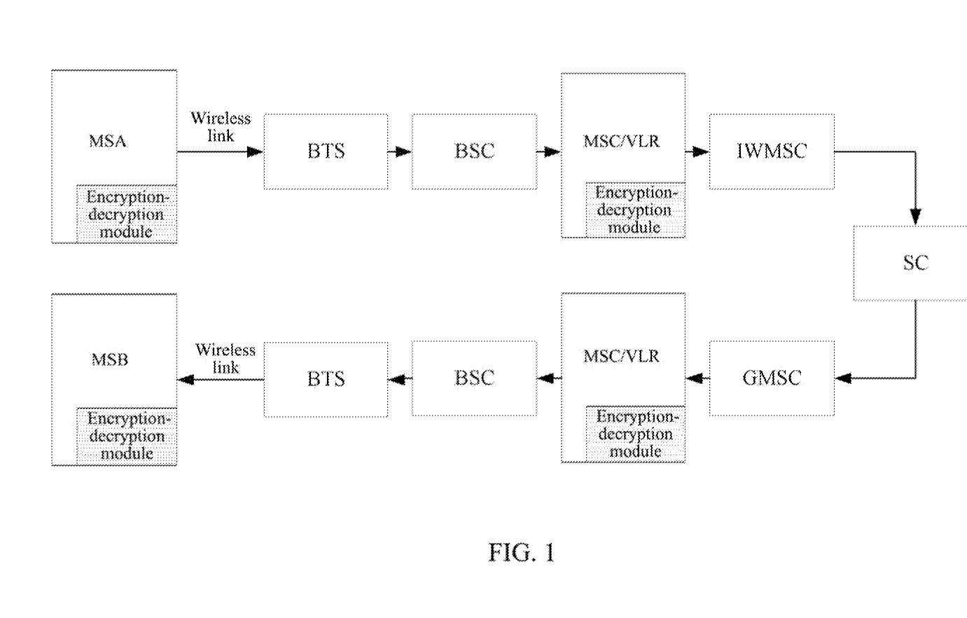

### PREFERRED EMBODIMENTS OF THE INVENTION

The basic concept of the present invention is that an encryption-decryption module is configured in the MS and MSC, and the encryption-decryption module encrypts and decrypts the user data (UD) of the short message using the CK (Cipher Key) as the encryption-decryption factor, thereby enhancing the security of the wireless transmission environment of the short message. Optionally, suitable configuration may be also implemented to achieve the security of the short message in the subsequent network environment, thereby achieving the security of the whole transmission environment.

The method for implementing short message encryption according to the example of the present invention comprises the following steps:

Step 1, the MS (also called as MS A) of the transmitting party encrypts the UD of the PDU of the short message to be transmitted using the CK of the transmitting party as the encryption factor through an encryption-decryption module of itself, sets an encryption identifier in the PDU of the short message to be transmitted, and then sends the short message out;

Step 2, after the short message reaches the MSC to which the MS A belongs via a BSS (Base Station Subsystem, comprising a BTS (Base Transceiver Station) and a BSC (Base Station Controller)) and the MSC receives the short message, if judging according to the encryption identifier therein that the short message is an encrypted short message, the MSC decrypts the UD of the PDU of the short message using the CK of the transmitting party as the decryption factor through an encryption-decryption module of itself, and then sends the short message to an SC (service center) through an IWMSC (interworking message service center);

Step 3, after the MSC to which the MS of the receiving party belongs receives the short message transmitted by the SC through the GMSC (Gateway Mobile Switching Center), if it is judged according to the encryption identifier therein that the short message needs to be encrypted, the MSC to which the MS of the receiving party belongs encrypts the UD of the PDU of the short message using the CK of the receiving party as an encryption factor through its encryption-decryption module and then sends the short message to the MS (which may be called as MS B) of the receiving party through the BTS and BSC to which the MS of the receiving party belongs;

Step 4, after receiving the short message, if judging according to the encryption identifier therein that the short message is an encrypted short message, the MS B decrypts the UD of the PDU of the short message using the CK of the receiving party as the decryption factor through an encryption-decryption module of itself, thereby restoring the content of the short message.

Wherein, the above steps 1 and 2 are flows of transmitting an encrypted short message, while steps 3 and 4 are flows of receiving an encrypted short message.

The above steps can ensure the secure transmission of the short message in the wireless link and between the MS and MSC. In order to ensure secure transmission on the MSC-IWMSCSC-GMSC-MS link, optionally, in step 2, after the MSC to which the MS of the transmitting party belongs decrypts the UD of the PDU of the short message, it encrypts the UD of the PDU of the short message using the user identifier of the receiving party as the encryption factor through an encryption-decryption module of itself, and then sends the short message to the SC through the IWMSC;
correspondingly, in step 3, after receiving the short message transmitted by the SC through the GMSC, if it is judged according to the encryption identifier therein that the short message needs to be encrypted, the MSC to which the MS of the receiving party belongs firstly decrypts the UD of the PDU of the short message using the user identifier of the receiving party as the decryption factor through the encryption-decryption module of itself, and then encrypts the UD of the PDU of the short message using the CK of the receiving party as the encryption factor.

The optional steps (encrypting or decrypting using the user identifier of the receiving party as the encryption factor) of the above steps 2 and 3 should be present or absent simultaneously in the whole system so as to ensure the consistence of the whole system.

The above user identifier of the receiving party is MSISDN (Mobile Subscriber International ISDN/PSTN number) or IMSI (International Mobile Subscriber Identification Number) of the receiving party.

The above encryption-decryption module is not limited to a software encryption-decryption module, and may be a hardware encryption-decryption module, and even may be a hardware encryption-decryption module capable of updating the encryption-decryption algorithm.

The CK is calculated with a particular algorithm (for example, the A8 algorithm is used in the GSM system) from a random value (RAND) generated in an authentication process of the MS and MSC and a root key (Ki) of a user. RAND is a random number distributed to the MS during the authentication process of the network for the user when the signaling link is established. Ki is a secure key (128 bit) shared by the USIM (Universal Subscriber Identity Module) and the HLR/AUC (home location register/authentication center) of the home network.

The encryption identifier may be implemented using the remaining Bits of the PDU or by means of an extended field.

In addition, in step 1, optionally, the MS may provide an interface for the user of the transmitting party to select whether to encrypt the short message to be transmitted, and if the user of the transmitting party select to encrypt, the MS of the transmitting party encrypts the UD of the PDU of the short message to be transmitted.

The system in the example of the present invention comprises the MS of the transmitting party, the MSC to which the MS of the transmitting party belongs, the MSC to which the MS of the receiving party belongs, and the MS of the receiving party, as described above.

In the present invention, in order to transmit the encrypted short message more safely, the modification is only to configure an encryption-decryption module in the MS and the MSC, and other fixed flows of short message are not changed.

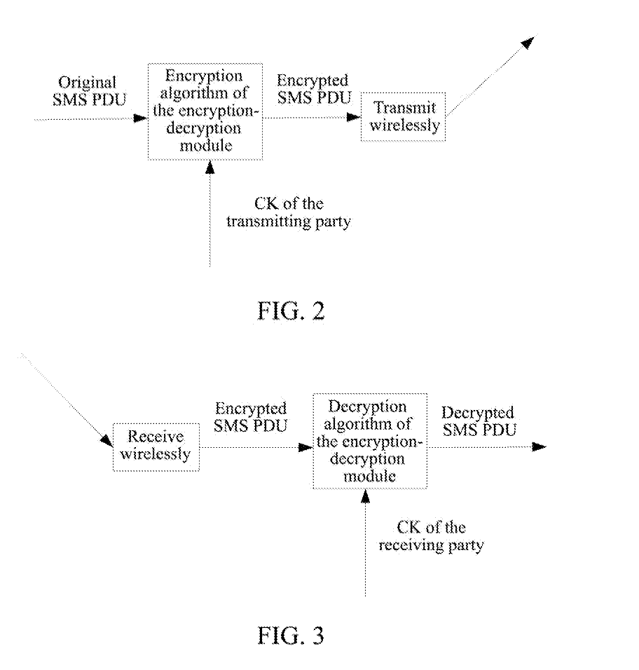

FIG. 2 is the flow of the MS sending an encrypted short message, and this figure describes the process of encrypting a short message.

When the user completely edits the short message and organizes the PDU data of the short message and prepares to send it out, if the user selects to encrypt the short message, the MS encrypts the user data part of the PDU of the short message using its own CK (the CK of the transmitting party) as the encryption factor of the encryption-decryption module, and then sets the short message with an encryption short message identifier, and finally transmits the short message via an air interface. As the specific implementation, the remaining bits Bit3 and Bit2 in the DSC data coding standard of the PDU can be optionally used as 11 for the encryption identifier (currently the 11 combination is not used yet). This step can ensure the high security of wireless transmission. If the user selects not to encrypt the short message, the short message is directly transmitted via the air interface according to the normal flow. In order to simplify the description, the subsequent description only involves the processing flow of short message decryption, since non-encryption of short message uses the normal flow.

FIG. 3 is the flow of the MS receiving an encrypted short message, and this figures describes how the MS receives the encrypted short message.

After the MS receives a short message, it judges whether the encryption identifier is the encryption mode, if yes, it decrypts the user data part of the PDU of the short message using its own CK (the CK of the receiving party) as the decryption factor of the encryption-decryption module, thereby restoring the content of the short message.

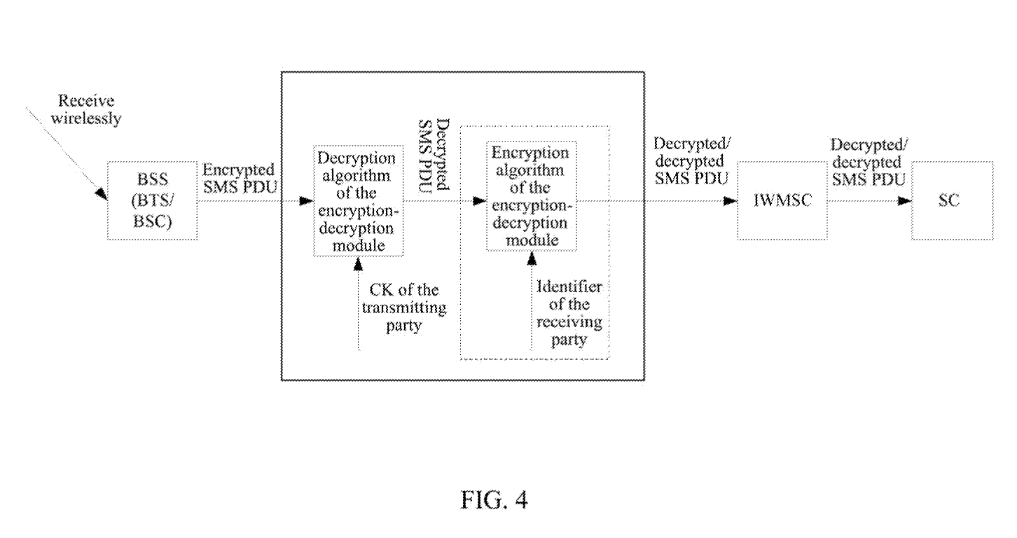

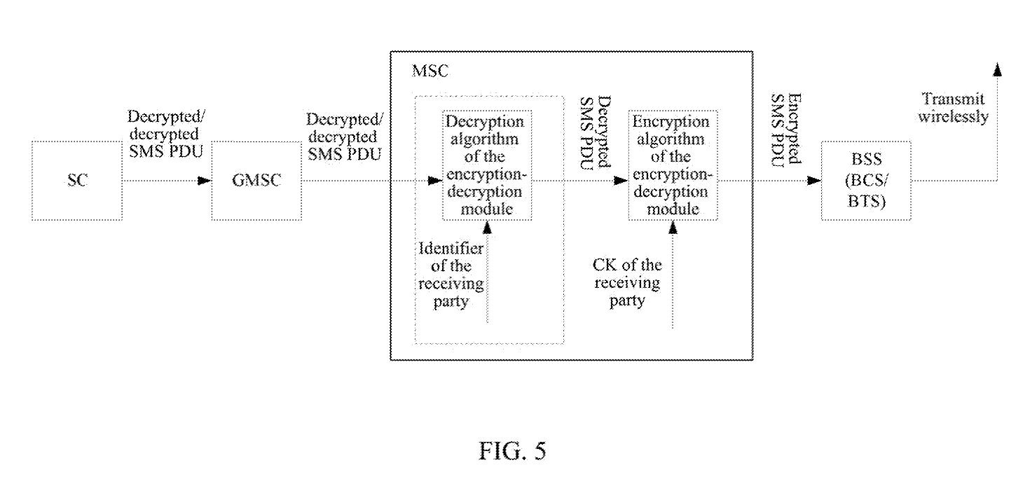

FIG. 4 is the flow of sending an encrypted short message to the short SC, and this figure describes how the encrypted short message sent from the MS is sent to the SC. Wherein, the dotted line block is an optional step.

The encrypted short message sent from the MS is sent to the MSC for further forwarding after being received by the BSS, and the MSC needs to judge whether the short message is an encrypted short message when receiving the PDU of the short message, and if yes, it needs to decrypt the short message using the same CK shared by the transmitting party as the decryption factor of the decryption algorithm of the encryption-decryption module. Here it should be noted that the reason that decryption must be performed is that the short message is transmitted according to the store-and-forward mechanism, and the CK obtained by the authentication of the transmitting party cannot be obtained by the receiving party. Even if the short message is decrypted here, the practice in the previous process has ensured the high security of the whole link from the MS to the MSC. In order to ensure the high security of the whole link from the MSC to the SC, we can implement further encryption operation optionally, and in order to ensure that the encryption operation can be correctly decrypted, the identifier of the receiving party is selected (the MSISDN may be selected as an example) as the encryption factor to encrypt the short message that has just been decrypted. Afterwards, the encrypted short message is always stored with encryption when being delivered to the IWMSC and finally to the SC, thereby ensuring the security of the link between the MSC and the SC. The security of the whole link can be ensured as long as the security of the encryption-decryption algorithm is ensured. Of course, the optional portion in the figure may not be used, thus the subsequently transmitted short message is a plaintext short message only with the encryption identifier, and the security of the link from the MSC to the SC will have a certain loss.

FIG. 5 is the flow of the SC sending an encrypted short message to the receiving party, and this figure describes how the SC transmits the received short message to the MS of the receiving party safely. Wherein, the dotted line block is an optional step, and is simultaneously present with the dotted line block in FIG. 4.

The work of the SC after receiving the short message is to further store and forward the short message to the receiving party. The SC firstly gives the whole message to the GMSC, the GMSC then searches for the MSC to which a plurality of receiving parties belong and further sends the short message to the MSC, and the MSC forwards the short message to the MS of the receiving party through the BSS after paging the MS of the receiving party and successfully authenticating. Before forwarding the short message, the MSC needs to judge whether the short message has an encrypted short message identifier. If there is no encrypted short message identifier, the MSC transmits the short message as a normal short message; otherwise, the user data of the PDU are firstly decrypted using the identifier of the receiving party as the decryption factor of the encryption-decryption module when the whole system is provided with the optional module, and when there is no optional module, the short message per se is the decrypted content and thus does not need to be decrypted; afterwards, as for the decrypted content, the user data of the PDU is encrypted using the CK of the receiving party as the encryption factor of the encryption-decryption module, and then the encrypted short message is sent to the receiving party through the BSS system. Here it should be pointed out that the optional module must be collectively configured entirely for the sake of avoiding the transmission of the key and convenience of subsequently updating the encryption-decryption module algorithm.

Correspondingly, the MS in the example of the present invention comprises a transmitting module, a receiving module and an encryption-decryption module, the encryption-decryption module comprises an encryption sub-module and a decryption sub-module, wherein, the encryption sub-module is configured to encrypt a short message to be transmitted using a current CK as an encryption factor, and send the short message out through the transmitting module;
the decryption sub-module is configured to decrypt the short message received by the receiving module using the current CK as a decryption factor, thereby restoring the content of the short message.

Optionally, the MS further comprises an interface module,
the interface module is configured to provide an interface for a user to select whether to encrypt the short message to be transmitted, and if the user selects to encrypt, inform the encryption module so that the encryption module encrypts the short message to be transmitted.

Correspondingly, the MSC in the example of the present invention comprises a transmitting module and a receiving module, as well as an encryption-decryption module, the encryption-decryption module comprises an encryption sub-module and a decryption sub-module, wherein,
the decryption sub-module is configured to decrypt the short message using the CK of the transmitting party as a decryption factor after the receiving module receives the short message from the MS of the transmitting party, and then send the short message to a service center (SC) through the transmitting module;
the encryption sub-module is configured to encrypt the short message using a CK of the receiving party as an encryption factor after the receiving module receives the short message from the SC and then send the short message to the MS of the receiving party.

Optionally, the encryption sub-module is further configured to, after the decryption sub-module decrypts the short message using the CK of the transmitting party, encrypt the short message using a user identifier of the receiving party as the encryption factor, and then transmit the short message to the SC through the transmitting module; the decryption sub-module is further configured to, after the receiving module receives the short message from the SC, firstly decrypt the short message using the user identifier of the receiving party as the decryption factor, and then encrypt the short message using the CK of the receiving party as the encryption factor through the encryption sub-module.

A person having ordinary skill in the art can appreciate that all or part of the steps of the above method may be implemented by instructing related hardware with a program, which may be stored in a computer-readable medium, such as a read-only memory, a magnetic disk or an optical disk. Optionally, all or part of the steps of the above examples may also be implemented by using one or more integrated circuits. Correspondingly, each module/unit in the above examples may be implemented in the form of hardware, or in the form of software functional modules. The present invention is not limited to any particular form of combination of hardware and software.

The above examples are only preferred examples of the present invention, and are not used to limit the present invention. For a person having ordinary skill in the art, the present invention may have various modifications and changes. Any modification, equivalent substitution and improvement made within the spirit and principle of the present invention should be embodied in the protection scope of the present invention.

### INDUSTRIAL APPLICABILITY

In the present invention, by adding a corresponding encryption-decryption module into the MS and MSC, the short message is encrypted and decrypted using the CK which is variable with the RAND (random value) as the encryption-decryption factor, so as to ensure that the network, terminal device supplier and operator cannot steal the encrypted short message, and to ensure secure transmission of SMS. In addition, in the scheme of the present invention, the encryption factor is different at each time, which increases the difficulty of cracking from the wireless transmission environment. Besides, the security of the whole transmission environment can be achieved through optional configurations.

What is claimed is:

1. A method for implementing short message encryption, comprising the following steps of:
a mobile station (MS) of a transmitting party encrypting a short message to be transmitted using a cipher key (CK) of the transmitting party as an encryption factor and then sending the short message out;
a mobile switching center (MSC) to which the MS of the transmitting party belongs decrypting the short message using the CK of the transmitting party as a decryption factor after receiving the short message, and then sending the short message to a short message service center (SC) through an interworking message service center (IWMSC);
after receiving the short message transmitted by the SC through a gateway mobile switching center (GMSC), an MSC to which an MS of a receiving party belongs encrypting the short message using a CK of the receiving party as an encryption factor and then sending the short message to the MS of the receiving party;
after receiving the short message, the MS of the receiving party decrypting the short message using the CK of the receiving party as a decryption factor, thereby restoring a content of the short message.

2. The method according to claim 1, wherein,
the step of the MS of the transmitting party encrypting a short message to be transmitted using the CK of the transmitting party as an encryption factor and then sending the short message out comprises: the MS of the transmitting party encrypting user data (UD) of a protocol data unit (PDU) of the short message to be transmitted using the CK of the transmitting party as the encryption factor through an encryption-decryption module of itself, setting an encryption identifier in the PDU of the short message to be transmitted, and then sending the short message out;
the step of the MSC to which the MS of the transmitting party belongs decrypting the short message using the CK of the transmitting party as a decryption factor after receiving the short message comprises: after receiving the short message, if judging according to the encryption identifier therein that the short message is an encrypted short message, the MSC to which the MS of the transmitting party belongs decrypting the UD of the PDU of the short message using the CK of the transmitting party as the decryption factor through an encryption-decryption module of itself;
the step of the MSC to which the MS of the receiving party belongs encrypting the short message using the CK of the receiving party as an encryption factor after receiving the short message comprises: after receiving the short message, if judging according to the encryption identifier therein that the short message needs to be encrypted, the MSC to which the MS of the receiving party belongs encrypting the UD of the PDU of the short message using the CK of the receiving party as the encryption factor through an encryption-decryption module of itself;
the step of the MS of the receiving party decrypting the short message using the CK of the receiving party as a decryption factor after receiving the short message comprises: after receiving the short message, if judging according to the encryption identifier therein that the short message is an encrypted short message, the MS of the receiving party decrypting the UD of the PDU of the short message using the CK of the receiving party as the decryption factor through an encryption-decryption module of itself.

3. The method according to claim 2, wherein,
after decrypting the UD of the PDU of the short message, the MSC to which the MS of the transmitting party belongs encrypts the UD of the PDU of the short message using a user identifier of the receiving party as the encryption factor through the encryption-decryption module of itself, and then transmits the short message to the SC through the IWMSC;
after receiving the short message transmitted by the SC through the GMSC, if it is judged according to the encryption identifier therein that the short message needs to be encrypted, the MSC to which the MS of the receiving party belongs firstly decrypts the UD of the PDU of the short message using the user identifier of the receiving party as the decryption factor through the encryption-decryption module of itself, and then encrypts the UD of the PDU of the short message using the CK of the receiving party as the encryption factor.

4. The method according to claim 1, wherein,
the CK is calculated with a particular algorithm from a random value (RAND) of generated in an authentication process of the MS and MSC of a party to which the CK belongs and a root key (Ki) of a user.

5. The method according to claim 3, wherein,
the user identifier of the receiving party is a mobile subscriber international ISDN number (MSISDN) or International Mobile Subscriber Identification Number (IMSI) of the receiving party.

6. The method according to claim 1, wherein,
before the MS of the transmitting party encrypts the short message to be transmitted, the MS provides an interface for the user of the transmitting party to select whether to encrypt the short message to be transmitted, and if the user of the transmitting party selects to encrypt, the MS of the transmitting party encrypts the short message to be transmitted.

7. A method for transmitting an encrypted short message, comprising the following steps of:
a mobile station (MS) of a transmitting party encrypting a short message to be transmitted using a cipher key (CK) of the transmitting party as an encryption factor and then sending the short message out;
a mobile switching center (MSC) to which the MS of the transmitting party belongs decrypting the short message using the CK of the transmitting party as a decryption factor after receiving the short message, and then sending the short message to a short message service center (SC) through an interworking message service center (IWMSC).

8. The method according to claim 7, wherein,
the step of the MS of the transmitting party encrypting a short message to be transmitted using the CK of the transmitting party as an encryption factor and then sending the short message out comprises: the MS of the transmitting party encrypting user data (UD) of a protocol data unit (PDU) of the short message to be transmitted using the CK of the transmitting party as the encryption factor through an encryption-decryption module of itself, setting an encryption identifier in the PDU of the short message to be transmitted, and then sending the short message out;
the step of the MSC to which the MS of the transmitting party belongs decrypting the short message using the CK of the transmitting party as a decryption factor after receiving the short message comprises: after receiving the short message, if judging according to the encryption identifier therein that the short message is an encrypted short message, the MSC to which the MS of the transmitting party belongs decrypting the UD of the PDU of the short message using the CK of the transmitting party as the decryption factor through an encryption-decryption module of itself.

9. The method according to claim 8, wherein,
after decrypting the UD of the PDU of the short message, the MSC to which the MS of the transmitting party belongs encrypts the UD of the PDU of the short message using a user identifier of the receiving party as the encryption factor through the encryption-decryption module of itself, and then transmits the short message to the SC through the IWMSC.

10. A method for receiving an encrypted short message, comprising the following steps of:
after receiving the short message transmitted by a short message service center (SC) through a gateway mobile switching center (GMSC), an mobile switching center (MSC) to which a mobile station (MS) of a receiving party belongs encrypting the short message using a cipher key (CK) of the receiving party as an encryption factor and then sending the short message to the MS of the receiving party;
after receiving the short message, the MS of the receiving party decrypting the short message using the CK of the receiving party as a decryption factor, thereby restoring a content of the short message.

11. The method according to claim 10, wherein,
the step of the MSC to which the MS of the receiving party belongs encrypting the short message using the CK of the receiving party as an encryption factor after receiving the short message comprises: after receiving the short message, if judging according to the encryption identifier therein that the short message needs to be encrypted, the MSC to which the MS of the receiving party belongs encrypting the UD of the PDU of the short message using the CK of the receiving party as the encryption factor through an encryption-decryption module of itself;
the step of the MS of the receiving party decrypting the short message using the CK of the receiving party as a decryption factor after receiving the short message comprises: after receiving the short message, if judging according to the encryption identifier therein that the short message is an encrypted short message, the MS of the receiving party decrypting the UD of the PDU of the short message using the CK of the receiving party as the decryption factor through an encryption-decryption module of itself.

12. The method according to claim 11, wherein,
after receiving the short message transmitted by the SC through the GMSC, if it is judged according to the encryption identifier therein that the short message needs to be encrypted, the MSC to which the MS of the receiving party belongs firstly decrypts the UD of the PDU of the short message using the user identifier of the receiving party as the decryption factor through the encryption-decryption module of itself, and then encrypts the UD of the PDU of the short message using the CK of the receiving party as the encryption factor.

13. A system for implementing short message encryption, comprising a mobile station (MS) of a transmitting party, a mobile switching center (MSC) to which the MS of the transmitting party belongs, an MSC to which an MS of a receiving party belongs, the MS of the receiving party, and the MS and MSC of the transmitting party and the MS and MSC of the receiving party being all configured with encryption-decryption modules, wherein,
the MS of the transmitting party is configured to encrypt a short message to be transmitted using a cipher key (CK) of the transmitting party as an encryption factor through the encryption-decryption module of itself and then send the short message out;
the MSC to which the MS of the transmitting party belongs is configured to decrypt the short message using the CK of the transmitting party as a decryption factor after receiving the short message, and then send the short message to a short message service center (SC) through an interworking message service center (IWMSC);
the MSC to which the MS of the receiving party belongs is configured to encrypt the short message using a CK of the receiving party as an encryption factor through the encryption-decryption module of itself after receiving the short message transmitted by the SC through the GMSC and then send the short message to the MS of the receiving party;
the MS of the receiving party is configured to decrypt the short message using the CK of the receiving party as a decryption factor through the encryption-decryption module of itself after receiving the short message, thereby restoring a content of the short message.

14. (canceled)

15. (canceled)

16. (canceled)

17. (canceled)
